(19) United States
(12) Patent Application Publication
(10) Pub. No.: US 2020/0410818 A1
(43) Pub. Date: Dec. 31, 2020

(54) Computer Implemented Method and Apparatus for Operating a Mystery Jackpot

(71) Applicant: Paltronics Australasia Pty Limited, Taren Point, New South Wales (AU)

(72) Inventors: Dean Wright, Taren Point, NSW (AU); Stephen Cowan, (US)

(21) Appl. No.: 16/907,653

(22) Filed: Jun. 22, 2020

(30) Foreign Application Priority Data
Jun. 27, 2019 (AU) 2019204563

(51) Int. Cl. G07F 17/32

(52) U.S. Cl. CPC G07F 17/3258; G07F 17/323; G07F 17/3267

(57) ABSTRACT

There is disclosed a method, apparatus and associated mathematics for the implementation of a hidden jackpot into a mystery jackpot and the use of the funds in the hidden jackpot to contribute to the startout value to be used in the next mystery jackpot. Various embodiments include parameter selection criteria and operating considerations intended to ameliorate concerns associated with volatility, player fairness and harm minimisation.

### FIELD OF THE INVENTION

The present invention relates to a computer implemented method and apparatus for operating a mystery jackpot. Embodiments of the present invention find application, though not exclusively, in the gaming industry for use with linked networks of electronic gaming machines.

### BACKGROUND OF THE INVENTION

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

It is known to link a number of electronic gaming machines to form a network. Such networks may be linked to a controller, such as a server, to provide a secondary game such as a jackpot game in which each of the linked electronic gaming machines may participate. This secondary game is typically provided in addition to the primary game of the electronic gaming machines, which may for example be slots, poker, blackjack, bingo, keno, or the like. The players of the linked electronic gaming machines each contribute to, and may win, a jackpot prize.

One particularly popular secondary game is known to those skilled in the art as a “mystery jackpot”. A typical implementation of a mystery jackpot involves a gaming controller commencing a jackpot at a startout amount and then incrementing the jackpot by a proportion of the turnover of the linked electronic gaming machines (EGM)'s. The current value of the jackpot is typically displayed to the players. Additionally, the players are advised that the jackpot will be won when it has been incremented to be equal to, or greater than, a mystery trigger value (i.e. a value that is known to the gaming controller but is not known by the players). The players are also advised of a maximum jackpot value by which the jackpot must be won. In some implementations, the jackpot is awarded to the player of the EGM that contributed the funds that incremented the jackpot past the mystery trigger value. In other implementations, the jackpot is awarded to a subset, or to all, of the active linked EGM's at the time when the jackpot award was triggered. Yet other implementations the jackpot alternates between incrementing towards a maximum (as described above) and decrementing towards a minimum.

It has been appreciated by the inventors of the present application that variations to the operation of mystery jackpots may contribute to increased player anticipation and excitement. Additionally, such variations may assist to reduce the volatility of such games in a manner that may be advantageous to the gaming operator.

### SUMMARY OF THE INVENTION

It is an object of the present invention to overcome, or substantially ameliorate, one or more of the disadvantages of the prior art, or to provide a useful alternative.

In one aspect of the present invention there is provided a method of operating a mystery jackpot, said method including the steps of:

initialising a variable representing a jackpot amount to a startout value;

initialising a variable representing a limit;

initialising a variable representing a hidden jackpot;

initialising a variable representing a mystery trigger value to a value that lies between the startout value and the limit;

receiving a signal including data indicative of gaming activity;

calculating a first increment in dependence upon said data and incrementing the variable representing the jackpot amount by the first increment;

calculating a second increment in dependence upon said data and incrementing the variable representing the hidden jackpot by the second increment;

awarding a jackpot when the jackpot amount has a predefined relationship to the mystery trigger value and commencing a next mystery jackpot wherein a startout value of the next mystery jackpot includes funds from the hidden jackpot.

Preferably the second increment is less than, or equal to, the first increment.

Preferably the startout value of the next mystery jackpot includes between 95% to 100% of the funds in the hidden jackpot.

In one embodiment the jackpot amount is displayed to at least some players and the hidden jackpot is not displayed to said players.

Preferably the data indicative of gaming activity is indicative of a turnover within a polling period of at least one electronic gaming machine.

Preferably the step of calculating the first increment includes multiplying the turnover by a first multiple and the step of calculating the second increment includes multiplying the turnover by a second multiple.

An embodiment of the invention includes initialising the variable representing a hidden jackpot to include funds to be dispersed.

A second aspect of the present invention provides a computing apparatus having a processor configured to perform the method as described above.

The features and advantages of the present invention will become further apparent from the following detailed description of preferred embodiments, provided by way of example only, together with the accompanying drawings.

### BRIEF DESCRIPTION OF THE ACCOMPANYING DRAWINGS

The patent or application file contains at least one drawing executed in color. Copies of this patent or patent application publication with color drawing(s) will be provided by the Office upon request and payment of the necessary fee.

FIG. 1 is a schematic representation of an embodiment of the present invention;

FIG. 2 is a flowchart showing steps performed in an embodiment of the inventive method;

FIG. 3 is a table showing mystery jackpot parameters and other associated calculated values for a first worked example of an implementation of the invention in the column labelled “Level 1 with Hidden” and comparison figures for a prior art implementation of a mystery jackpot with an identical RTP in the column labelled “Level 1 with No Hidden”; and

FIG. 4 is a table showing mystery jackpot parameters and other associated calculated values for a first additional example of an implementation of the invention and comparison figures for a prior art implementation of a mystery jackpot with an identical RTP;

FIG. 5 is a graphical depiction of a simulation of the performance of the first additional example of an implementation of the invention and the prior art implementation of mystery jackpots having the parameters shown in the table of FIG. 4;

FIG. 6 is a table showing mystery jackpot parameters and other associated calculated values for a second additional example of an implementation of the invention and comparison figures for a prior art implementation of a mystery jackpot with an identical RTP;

FIG. 7 is a graphical depiction of a simulation of the performance of the second additional example of an implementation of the invention and the prior art implementation of mystery jackpots having the parameters shown in the table of FIG. 6;

FIG. 8 is a table showing mystery jackpot parameters and other associated calculated values for a third additional example of an implementation of the invention and comparison figures for a prior art implementation of a mystery jackpot with an identical RTP;

FIG. 9 is a graphical depiction of a simulation of the performance of the third additional example of an implementation of the invention and the prior art implementation of mystery jackpots having the parameters shown in the table of FIG. 8;

FIG. 10 is a table showing mystery jackpot parameters and other associated calculated values for a fourth additional example of an implementation of the invention and comparison figures for a prior art implementation of a mystery jackpot with an identical RTP;

FIG. 11 is a graphical depiction of a simulation of the performance of the fourth additional example of an implementation of the invention and the prior art implementation of mystery jackpots having the parameters shown in the table of FIG. 10;

FIG. 12 is a table showing mystery jackpot parameters and other associated calculated values for a fifth additional example of an implementation of the invention and comparison figures for a prior art implementation of a mystery jackpot with an identical RTP; and

FIG. 13 is a graphical depiction of a simulation of the performance of the fifth additional example of an implementation of the invention and the prior art implementation of mystery jackpots having the parameters shown in the table of FIG. 12.

### DETAILED DESCRIPTION OF PREFERRED EMBODIMENTS OF THE INVENTION

Some embodiments of the invention make use of certain elements of hardware and software similar to that disclosed in Patent Application No. PCT/AU2004/000964, the disclosure of which is incorporated herein by way of reference.

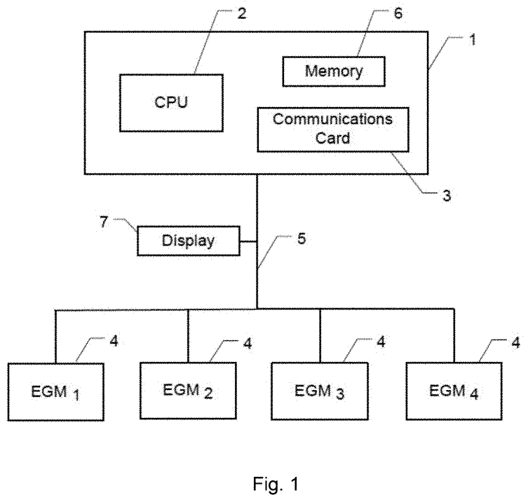

Referring to FIG. 1, the controller 1 has a processor in the form of a central processing unit (CPU) 2 and a communications card 3 that is operatively coupled to the CPU 2 and which communicatively links the controller 1 to a plurality of electronic gaming machines (EGM's) 4. In some embodiments the communications link 5 is provided by cables, a wireless link, a local area network, a wide area network, or a combination thereof. The EGM's 4 may be located within a single establishment or may be located in two or more geographically dispersed locations. Also operatively coupled to the CPU 2 is memory 6, which is typically in the form of random access memory or other readable and writable digital storage media such as hard drives, flash drives, and the like. The memory 6 includes a number of memory addresses, one of which is allocated to store a variable representing the current value of the jackpot amount and others of which are allocated to storing variables representing various other parameters and current values associated with the running of the mystery jackpot.

In the embodiment described above the controller 1 is a unit that is physically separate from the linked EGM's and which is dedicated to the running of the linked jackpot. However, in other embodiments the hardware that performs this functionality is disposed within at least one of the EGM's.

In some embodiments the CPU 2 is programmed to perform the inventive method by means of computer executable code stored on a computer readable medium, such as a CD-ROM, for example. In other embodiments the executable code is accessed either by means of downloading a file from a remote location, for example via the internet, or by means of remote execution, such as in a cloud computing context.

The CPU 2 has access to display driver software that is executable to cause the display 7 to display various messages to the players of the EGM's 4. In the illustrated embodiment the CPU is programmed to cause the display 7 to display the jackpot amount. Typically, one or more of the displays 7 are positioned such that they are viewable by all, or at least a majority of, the players of the EGM's 4 that are contributing to the linked jackpot for which the jackpot amount is being accumulated.

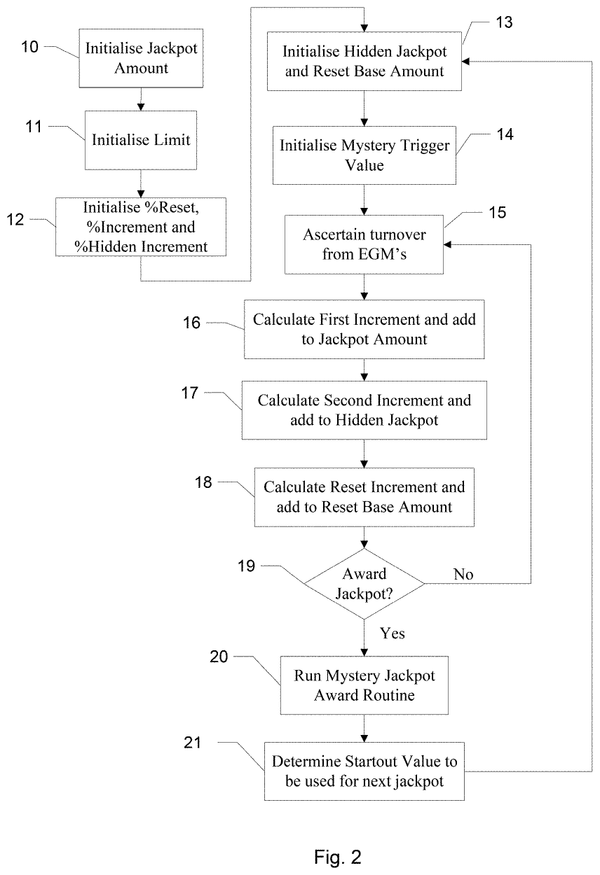

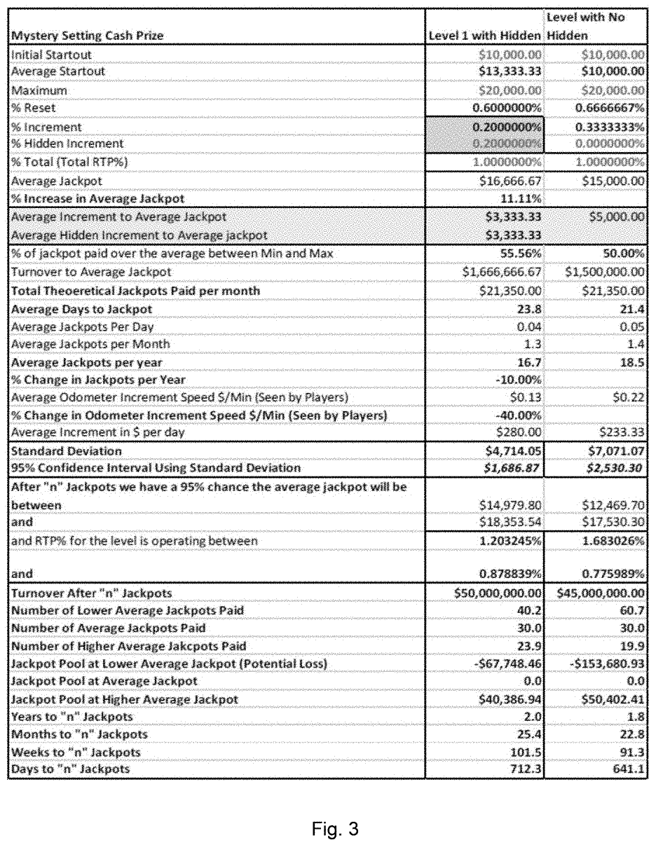

With reference to FIG. 2, the method of accumulating a jackpot amount commences with the step 10 with the CPU 2 initialising the variable representing the jackpot amount. By way of a non-limiting running worked example, the steps illustrated in FIG. 2 will be described with reference to the mystery jackpot parameters shown in the column in the table of FIG. 3 that is labelled “Level 1 with Hidden”. At commencement of the initial mystery jackpot in the running worked example, the variable representing the jackpot amount is initialised to a startout value of $10,000.00 immediately prior to polling period 1.

At step 11 the variable representing a limit is initialised to a pre-determined value, which in the running example is $20,000.00. This is a value that is advised to the players and the players are also informed that the mystery jackpot will be awarded at some point before the jackpot amount reaches this limit.

At step 12 variables representing some further parameters of the mystery jackpot are initialised. A variable shown in the table as “% Reset” is initialised to 0.6%. A variable shown in the table as “% Increment” is initialised to 0.2%. A variable shown in the table as “% Hidden Increment” is initialised to 0.2%. The manner in which the CPU 2 makes use of these variables is outlined in more detail below.

At step 13 the variable representing a hidden jackpot and another variable representing a reset base amount are initialised to pre-determined values, which in the running example is $0.00 for both variables. These two variables represent funds that can be used for the startout value of the next mystery jackpot. This explains why the table of FIG. 3 mentions an average startout value of $13,333.33, which is the average startout value over a large number of mystery jackpots.

The term “hidden jackpot” is used by those skilled in the art because such jackpots are not communicated, or displayed, to the players. Rather, they simply represent funds that the controller 1 accrues in the background.

At step 14 the variable representing a mystery trigger value is initialised to a value that lies between the startout value (i.e. $10,000.00 for the first iteration) and the limit (i.e. $20,000.00). The CPU makes use of a random number generator to determine mystery trigger value. For the running worked example we shall assume that a value of $16,285.20 is randomly selected for the first mystery jackpot.

At step 15 the CPU 2 ascertains a quantum of gaming activity. More particularly, the EGM's 4 with which the controller 1 is in communication are each programmed to send a signal to the controller 1 encoding data indicative of gaming activity. One such signal is sent per EGM 4 for each polling period and the data includes the turnover recorded by the EMG within the immediately preceding polling period. Each polling period extends for a predetermined length of time. As the signals are received by the controller 1, as shown at step 15 of FIG. 2, the data representing the turnover is extracted from the signal and stored in the memory 6. Once a turnover amount has been received for all of the participating EGM's 4, the CPU 2 of the controller 1 performs an addition of each of the individual turnover amounts to determine a global turnover amount for the relevant polling period and this global turnover figure is stored in memory 6. For the running example, we shall assume that the global turnover amount for the first polling period is $120.00.

At step 16 the CPU 2 calculates the first increment by multiplying the global turnover figure for the applicable polling period by a first multiple. In the running example the first multiple is the value of the % Increment variable, i.e. 0.2%. This gives a first increment of $0.24 for the first polling period. The variable representing the jackpot amount is then incremented by the first increment, which results in a jackpot amount of $10,000.24 for polling period 1.

At step 17 the CPU 2 calculates the second increment by multiplying the global turnover figure for the applicable polling period by a second multiple, which in the running example is the value of the % Hidden Increment variable, i.e. 0.2%. This gives a second increment of $0.24 for the first polling period. The variable representing the hidden jackpot is then incremented by the second increment, which results in a hidden jackpot of $0.24 for polling period 1.

At step 18 the CPU 2 calculates another increment by multiplying the global turnover figure for the applicable polling period by another multiple, which in the running example is the value of the % Reset variable, i.e. 0.6%. This gives an increment of $0.72 for the first polling period. The variable representing the base reset amount is then incremented by the second increment, which results in a base reset amount of $0.72 for polling period 1.

At step 19 the CPU 2 determines if an award of the jackpot has been triggered by checking if the jackpot amount has a predefined relationship to the mystery trigger value. In the preferred embodiment, an award of the jackpot is triggered when the jackpot amount is equal to, or exceeds, the mystery trigger value. The winning player is the player of the EGM that contributed the final contribution that incremented the jackpot amount to at or above the mystery trigger value. If no jackpot award has been triggered, the process flow loops back to step 15; whereas if a jackpot award has been triggered, the process flow proceeds to step 20 at which the jackpot is awarded and then to step 21 at which the parameters for the next jackpot are determined.

When the running example executes step 19 for the first time, the CPU 2 compares the jackpot amount (i.e. $10,000.24) to the mystery trigger value (i.e. $16,285.20) and determines that the predefined relationship does not exist because the jackpot amount is less than the mystery trigger value. Hence, the process flow loops back to step 15 and this looping continues until a total global turnover of $3,142,600 has occurred. By this point, the jackpot amount has been incremented by a total of $6285.20 from the initial value of $10,000.00 to the mystery trigger value of $16,285.20. Now, when executing step 19, the CPU 2 determines that an award of the jackpot has been triggered and the process flow proceeds to step 20.

At step 20 the CPU runs a mystery jackpot award routine, which in one embodiment awards the jackpot to the player of the EGM that contributed the funds that incremented the jackpot value to be equal to, or more than, the mystery jackpot trigger value. It will be appreciated that other award routines may be utilised, such as a so-called “Mystery Madness” approach in which the jackpot is awarded to some or all of the players active on the linked EGM's 4 at the time of the award.

At step 21 the CPU determines the startout value that is to be used for the next jackpot. The CPU firstly determines if the reset base amount is under, equal to, or over the initial startout amount (i.e. $10,000). If under, or equal to, then the full amount of the reset base amount will be allocated towards the startout value of the next jackpot. If over $10,000, then only the first $10,000 is allocated towards the startout value of the next jackpot. The reminder is treated as operator profit. To this amount the CPU 2 adds the hidden jackpot. If this addition yields $10,000 or more, then this becomes the startout value of the next jackpot. However, if this addition yields less than $10,000, then the startout value of the next jackpot is set at $10,000. The additional amount required to reach $10,000 is treated as operator loss.

The possibility for operator profit and loss is known as volatility, which is often a concern for the operator of the gaming system, at least in the short term. In the longer term, once enough jackpots have been awarded, the profits and the loses are likely to even each other out. However, particularly in relation to larger jackpots which are awarded less frequently, the potential for a short-term loss may be problematic for gaming system operators.

At step 21 in the running example, the hidden jackpot variable is $6,285.20 and the value of the reset base amount is $18,855.60. Hence, the CPU 2 determines that the reset base amount exceeds $10,000 and hence $10,000 is allocated from the reset base amount towards value of the next jackpot. The remaining $8,855.60 is treated as operator profit. The CPU 2 then adds the hidden jackpot to the $10,000, resulting in a startout value for the next jackpot of $16,285.20.

The process flow now loops back to step 13 for the running of the second jackpot with a startout jackpot value of $16,285.20. This is likely to contribute to player excitement as compared to commencing each new jackpot with the standard minimum amount of $10,000.00. At step 13 the hidden jackpot variable and reset base amount variable are re-initialised to $0.00. At step 14 the variable representing a mystery trigger value is re-initialised to a value that lies between the startout value (i.e. $16,285.20) and the limit (i.e. $20,000.00). The CPU makes use of a random number generator to determine mystery trigger value. The process flow now loops through steps 15 to 19 until the second jackpot is awarded, and so forth.

The table in FIG. 3 includes some calculations for the average performance of the mystery jackpot over ‘n’ jackpot awards. For n=Go, the average startout is $13,333.33 and the average jackpot is $16,666.67. However, the actual performance of the jackpot is random and hence over a finite number of jackpots, say n=30, the actual average is likely to vary from the long-term average. Those skilled in the art will appreciate that the statistical analysis techniques associated with standard deviation and confidence intervals are useful in analysing such situations. Importantly, the 95% confidence interval for this embodiment of the invention is $1,686.87, which means that after ‘n’ jackpots, there is a 95% chance that the average jackpot will be between $14,979.80 (i.e. $16,666.67−$1,686.87) and $18,353.54 (i.e. $16,666.67+$1,686.87). This compares to a confidence interval of $2,530.30 for the prior art implementation of a mystery jackpot in the column labelled “Level 1 with No Hidden” of the table of FIG. 3. Hence, for this prior art mystery jackpot there is a 95% chance that the average jackpot will be between $12,469.70 and $17,530.30. The smaller confidence interval for the embodiment of the present invention as compared to that of the prior art indicates that the embodiment of the present invention is likely to perform in a less volatile manner.

If, after 30 jackpots, the average of the jackpot amounts awarded during the operation of this embodiment of the invention is $16,666.67, then the operator losses will equal the operator profits. If the average is less than $16,666.67, then the operator makes a loss. If the average is more than $16,666.67, then the operator makes a profit. With reference to the lower end of the confidence interval range, if, after 30 jackpots, the average of the jackpot amounts awarded during the operation of this embodiment of the invention is $14,979.80, then the operator losses will be $67,748.46. With reference to the upper end of the confidence interval range, if, after 30 jackpots, the average of the jackpot amounts awarded during the operation of this embodiment of the invention is $18,353.54, then the operator profit will be $40,386.94.

By way of comparison, if after 30 jackpots, the average of the jackpot amounts awarded during the operation of the prior art mystery jackpot shown in FIG. 3 is $15,000, then the operator losses will equal the operator profits. With reference to the lower end of the confidence interval range, if, after 30 jackpots, the average of the jackpot amounts awarded during the operation of the prior art mystery jackpot is $12,469.70, then the operator losses will be $153,680.93. With reference to the upper end of the confidence interval range, if, after 30 jackpots, the average of the jackpot amounts awarded during the operation of the prior art mystery jackpot is $17,530.30, then the operator profit will be $50,402.41.

It follows from the preceding two paragraphs that the above-described embodiment of the invention is less volatile as compared to the prior art mystery jackpot having similar parameters as shown in FIG. 3. In particular, the embodiment of the invention offers significantly less potential for short-terms losses due to a run of jackpots averaging at the lower end of the confidence interval range as compared to the prior art mystery jackpot. This is likely to be attractive to at least some operators.

In addition to ameliorating the volatility in mystery jackpots, the preferred embodiment of the invention seeks to provide alternate types of jackpots to venues and players, as well as ensure that player fairness and gambling harm minimisation is considered.

From a player fairness viewpoint, it is preferable to ensure that the players who have contributed funds to the jackpot amount and to the hidden jackpot have an opportunity to win. This will occur when a jackpot is awarded, as all the players playing at the time have an opportunity to win the current jackpot, and continuing players will also have the opportunity to win when the next jackpot starts up as they will see the jackpot start at the minimum plus the increment added in part by their contribution to the hidden jackpot. If, on average, all or most of the funds incremented in the hidden pool are added back to the startout of the next jackpot, then those players that have contributed are eligible to win the new higher jackpot as well. However, the implementation may be considered unfair if accumulated funds remain in the hidden pool without being made available to be won.

Gambling harm minimisation is also considered in the selection of the mystery jackpot parameters, as it is not an objective to have excessive accumulated funds in the hidden pool, which will result in the jackpot pool often resetting to a value close to the maximum.

It assists to meet the above-mentioned goals if the mystery jackpot parameters are selected so as to ensure that the second increment is less than, or equal to, the first increment. It will be recalled from the above discussion of step 16 that the first increment is calculated by multiplying the global turnover figure for the applicable polling period by the % Increment variable. As mentioned earlier in relation to step 17, the second increment is calculated by multiplying the global turnover figure for the applicable polling period by the % Hidden Increment variable. Hence, it is possible ensure that the second increment is less than, or equal to, the first increment by setting the % Hidden Increment variable to be less than, or equal to, the % Increment variable.

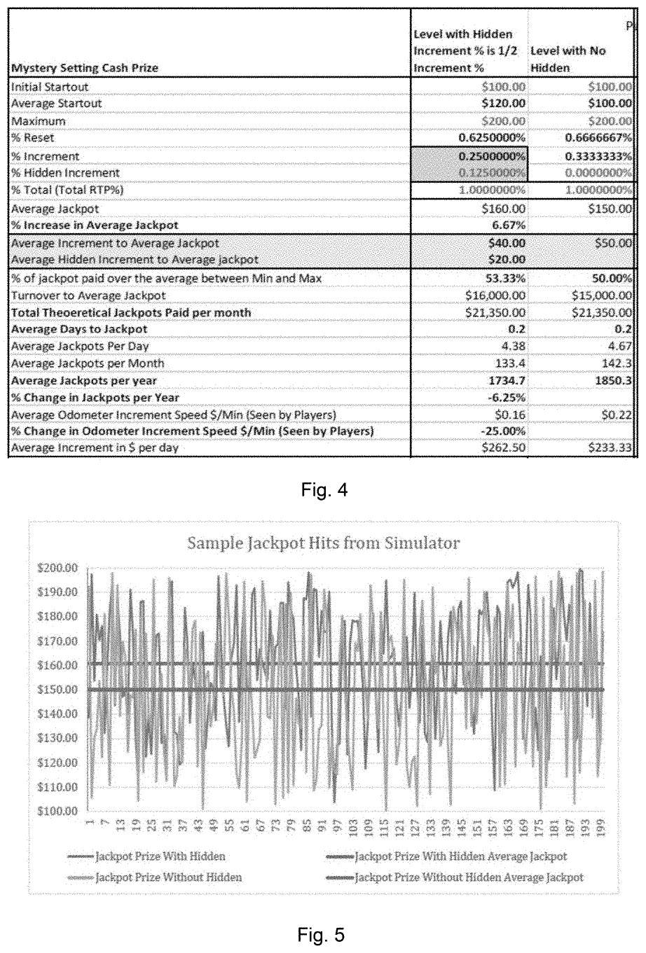

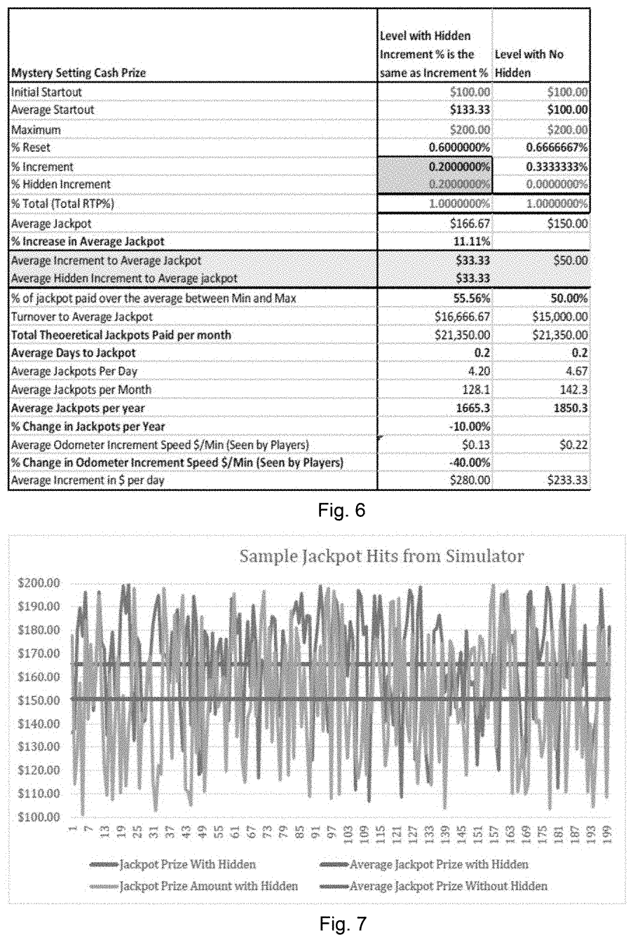

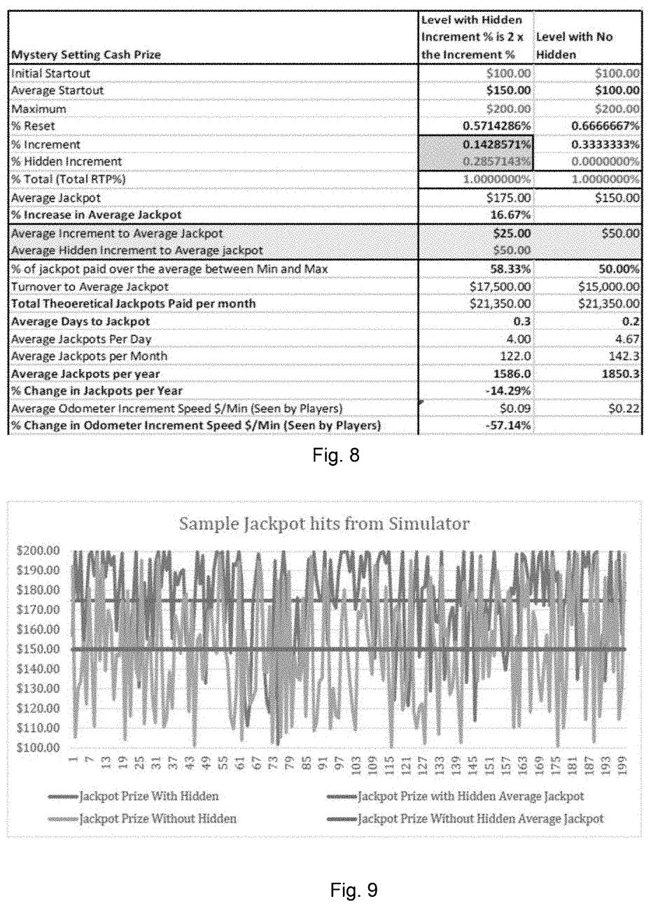

FIGS. 4 to 9 show some examples of the parameters, calculations and associated simulations of the effects when the % Hidden Increment parameter is set at various ratios of the % Increment parameter. In FIGS. 4 and 5 the % Hidden Increment is half the % Increment parameter. In FIGS. 6 and 7 the % Hidden Increment is the same as the % Increment parameter. In FIGS. 8 and 9 the % Hidden Increment is twice the % Increment parameter. All three of these additional example implementations provide the same RTP of 1%.

In the example implementation shown in FIGS. 4 and 5, the average increment to the average jackpot is $40 and the hidden jackpot will increment an average of $20 at each average jackpot hit. Hence, in this implementation the hidden pool will not continuously increase and 95% to 100% of the hidden jackpot can be made available to be won by players in each next jackpot.

In the example implementation shown in FIGS. 6 and 7, the average increment to the average jackpot is $33.33 and the hidden jackpot will increment an average of $33.33 at each average jackpot hit. Hence, in this implementation the hidden pool will not continuously increase and 95% to 100% of the hidden jackpot can be made available to be won by players in each next jackpot.

In the example implementation shown in FIGS. 8 and 9, the average increment to the average jackpot is $25.00 and the hidden jackpot will increment an average of $50.00 at each average jackpot hit. Hence, in this implementation the hidden pool may continuously increase because 95% to 100% of the hidden jackpot cannot be made available to be won by players in each next jackpot because that would result in something akin to the simulation shown in FIG. 9. The proportion of jackpot hits at the maximum is indicative of the jackpot system transferring too much from the hidden jackpot to the next startout value each time a jackpot is awarded. This is resulting in a high proportion of jackpots being awarded at or close to the maximum, which may be considered undesirable from a harm minimisation viewpoint. An alternative would be to transfer less of the hidden jackpot to the next jackpot startout value. Modelling of a system having the same parameters, but with the jackpot system transferring less of the hidden jackpot to the next jackpot startout value results in less jackpots being awarded at the top of the range; however after many jackpots this results in continuous growth of the hidden jackpot, which may be considered undesirable from a player fairness viewpoint. This is why the second increment should preferably be less than, or equal to, the first increment.

There may be situations in which it is necessary for a gaming operator to disperse funds into a jackpot game. One example of such a situation may occur when an operator de-commissions a linked secondary gaming system. The regulations of some jurisdictions stipulate that some of the funds accumulated in the de-commissioned gaming system must be dispersed into another jackpot system.

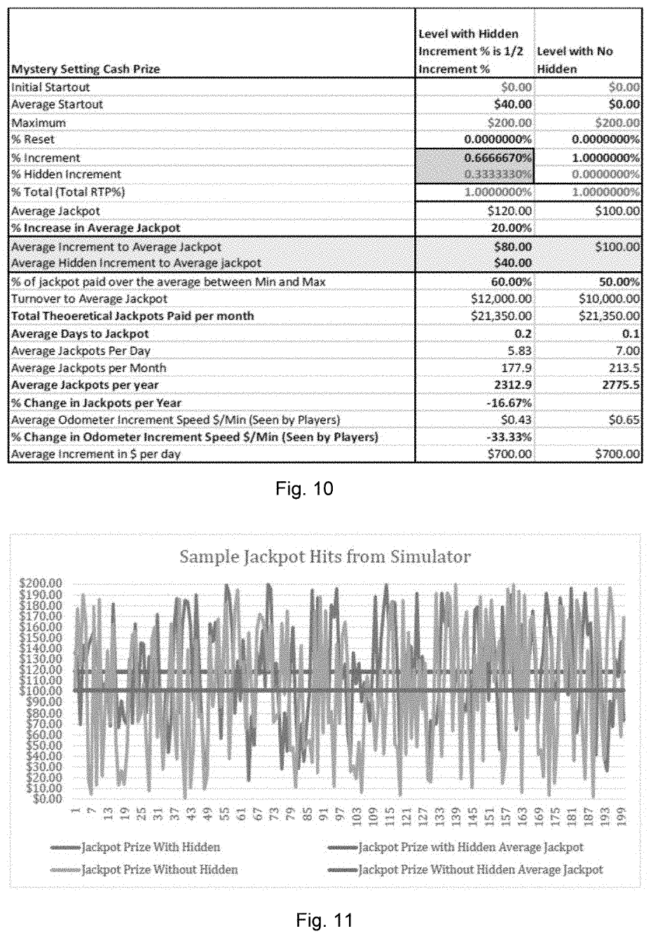

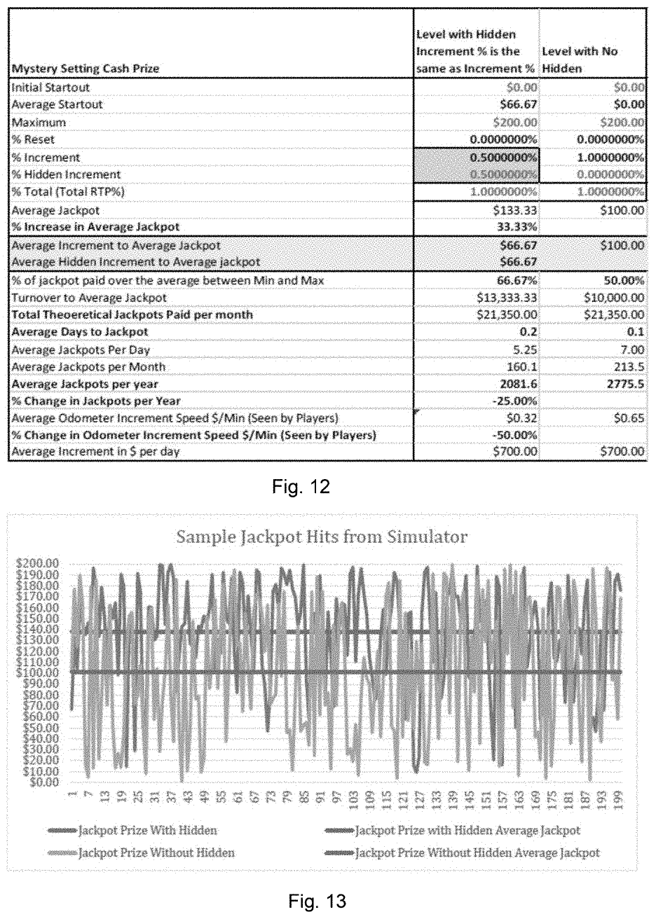

It has been appreciated by the inventor of the present invention that a mystery jackpot having a zero startout amount (or, more accurately, a mystery jackpot that is considered to be a zero startout mystery jackpot because the % Reset parameter is set to zero, despite the funds in the hidden jackpot being made available to provide non-zero startout amounts after the first jackpot has been awarded) provides a good platform for such a dispersal by helping to avoid unintended additional costs. The example implementations of jackpots illustrated in FIGS. 10 and 12, along with the simulations thereof in FIGS. 11 and 13, provide examples of mystery jackpots having zero startout amounts (in the sense mentioned above). Embodiments of this type may be used for the dispersing of funds by adding the funds to be dispersed into the hidden jackpot during jackpot initialisation. Then the funds are used at the award of each jackpot to provide a non-zero startout value for the next jackpot.

These embodiments do not require all of the funds of the hidden jackpot to be transferred to the startout amount of the next jackpot. Rather, these embodiments allow an operator to select a percentage of the difference between the minimum (i.e. the startout amount) and the maximum (i.e. the limit) to be deducted from the hidden jackpot and added to the startout amount each time a jackpot is awarded. For example, if the minimum was $100 and the maximum was $200 and a percentage of 95% is set, then 95% of the difference between the minimum and maximum is $95.00, and the next jackpot would start at $195. If there was $50 in the hidden jackpot, all of the funds would be transferred, because this is less than the $95, the next jackpot would start at $150. If there was $200 in the hidden jackpot then $95 would be transferred, resulting in the next jackpot starting at $195 and $105 would remain in the hidden pool until the next jackpot hit. This provides the operator with some control over the transfer of funds from the hidden jackpot to the startout value of the next jackpot. In situations where funds are to be dispersed, those funds may be added to the hidden jackpot during initialisation of the first jackpot and progressively transferred to the startout amount of the next jackpots until the funds to be dispersed are exhausted.

In the above-described examples the startout value was a lower value than the limit. However, in some embodiments, the startout value is higher than the limit and, as opposed to incrementing, the jackpot amount actually decrements towards the mystery trigger value and the jackpot is awarded when the jackpot amount is equal to, or less than, the mystery trigger value. As used in this document, including in the claims, terms such as “incrementing” and the like are to be construed so as to include “decrementing” and the like, or to include incrementing by a negative value.

With a prior art mystery jackpot the formula to calculate the average jackpot is (max−min)/2. With a mystery jackpot with a hidden increment %, as in the present invention, the formula to calculate the average jackpot is:

$$\frac{( Max + Min ) + \frac{( Max - Min ) * h \% )}{2 Inc \% + h \%}}{2}$$

With a prior art mystery jackpot the calculation for the RTP % is:

$$\frac{Inc \%}{1 - ( \frac{Minimum}{Average Jackpot} )}$$

When a hidden increment % is used, as in the present invention, the RTP % formula is:

$$\frac{Inc \%}{1 - ( \frac{Average Startup}{Average Jackpot} )}$$

Which is the same as:

$$RTP \% = \frac{Inc \% ( Max + Min ) + ( Hid \% \times Max ) }{( Max - Min )}$$

Other formulas that apply when a hidden increment % is introduced to a mystery jackpot with a fixed maximum, as in the present invention, are as follows:

Increment to Average Jackpot

$$\frac{( Max - Min )}{2 + ( \frac{h \%}{Inc \%} )}$$

Increment % Formula

### (When Hidden and RTP % is Entered)

$$\frac{RTP \% ( Max - Min ) - ( h \% Max )}{( Max + Min )}$$

Startout % Formula

$$\frac{Min \times ( 2 Inc \% + h \% )}{( Max - Min )}$$

As used in the above formulas:

h % is the percentage of turnover that accrues into the hidden jackpot (which was referred to as % hidden increment earlier in this specification).

Inc % is the percentage of turnover that accrues into the jackpot amount (which was referred to as % Increment earlier in this specification).

Min is the initial startout amount (i.e. the startout amount without any contribution from a previous jackpot).

Max is value by which the jackpot must have been awarded (which was referred to as a limit earlier in this specification).

As used in this patent specification, including within the claims, the term “jackpot amount” is to be construed broadly so as to include, by way of non-limiting example, a monetary amount and/or an amount of some other instrument of value, such as promotional points, or the like. Additionally, as used in this document, including within the claims, the terms “random”, “randomly”, and the like, are to be construed as connoting either a purely random process or a “pseudo-random” process. An example of a pseudo-random process includes the determination by a computer processor of a pseudo-random number in response to an output of a digital clock.

It will be appreciated by those skilled in the art that the EGM's 4 with which the controller 2 communicates may be any one or combination of: dedicated electronic gaming machines, such as slot machines for example; other electronic devices capable of being programmed to provide the necessary functionality, including computers connected via a communications network such as the internet; hand held devices such as mobile phones, personal digital assistants; and the like.

While a number of preferred embodiments have been described, it will be appreciated by persons skilled in the art that numerous variations and/or modifications may be made to the invention without departing from the spirit or scope of the invention as broadly described. The present embodiments are, therefore, to be considered in all respects as illustrative and not restrictive.

The claims defining the invention are as follows:

1. A computer implemented method of operating a mystery jackpot, said method including the steps of:
initialising a variable representing a jackpot amount to a startout value;
initialising a variable representing a limit;
initialising a variable representing a hidden jackpot;
initialising a variable representing a mystery trigger value to a value that lies between the startout value and the limit;
receiving a signal including data indicative of gaming activity;
calculating a first increment in dependence upon said data and incrementing the variable representing the jackpot amount by the first increment;
calculating a second increment in dependence upon said data and incrementing the variable representing the hidden jackpot by the second increment;
awarding a jackpot when the jackpot amount has a predefined relationship to the mystery trigger value and commencing a next mystery jackpot wherein a startout value of the next mystery jackpot includes funds from the hidden jackpot.

2. A method according to claim 1 wherein the second increment is less than, or equal to, the first increment.

3. A method according to claim 1 wherein said startout value of the next mystery jackpot includes between 95% to 100% of the funds in the hidden jackpot.

4. A method according to claim 1 wherein the jackpot amount is displayed to at least some players and the hidden jackpot is not displayed to said players.

5. A method according to claim 1 wherein the data indicative of gaming activity is indicative of a turnover within a polling period of at least one electronic gaming machine.

6. A method according to claim 5 wherein the step of calculating the first increment includes multiplying the turnover by a first multiple and the step of calculating the second increment includes multiplying the turnover by a second multiple.

7. A method according to claim 1 including initialising the variable representing a hidden jackpot to include funds to be dispersed.

8. A computing apparatus having a processor configured to perform a method including the steps of:
initialising a variable representing a jackpot amount to a startout value;
initialising a variable representing a limit;
initialising a variable representing a hidden jackpot;
initialising a variable representing a mystery trigger value to a value that lies between the startout value and the limit;
receiving a signal including data indicative of gaming activity;
calculating a first increment in dependence upon said data and incrementing the variable representing the jackpot amount by the first increment;
calculating a second increment in dependence upon said data and incrementing the variable representing the hidden jackpot by the second increment;
awarding a jackpot when the jackpot amount has a predefined relationship to the mystery trigger value and commencing a next mystery jackpot wherein a startout value of the next mystery jackpot includes funds from the hidden jackpot.
